(19) United States
(12) Patent Application Publication
(10) Pub. No.: US 2007/0284901 A1
(43) Pub. Date: Dec. 13, 2007

(54) TALL EXTRUSION FASTENING ASSEMBLY

(75) Inventors: Landon Ball, North Augusta, SC (US); Albert Packard, Evans, GA (US); Bradley J. Hanson, North Augusta, SC (US); Donald S. Hanson, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,316

(22) Filed: May 19, 2006

(51) Int. Cl. B62D 27/00

(52) U.S. Cl. 296/29

(57) ABSTRACT

According to the present disclosure, a raised projection or extrusion on a component of a small utility vehicle can be used to secure other components of the vehicle together. The extrusion can receive a fastener therein to hold the components together. The extrusion can be relatively rigid and engage directly with the fastener or indirectly with the fastener through other relatively rigid members, such as a washer. The extrusion can limit the compressive load imparted by the fastener on the other components. The engagement between the fastener and the extrusion can maintain the clamping load imparted between the fastener and the extrusion regardless of creeping of one or more components being secured by the fastener and extrusion.

### FIELD

The present disclosure relates to a fastening assembly using an extrusion and a method for fastening components of a small utility vehicle, such as a golf car.

### BACKGROUND

The statements in this section merely provide background information related to the present disclosure and may not constitute prior art.

Small utility vehicles can include: golf cars, shuttle personnel carriers, refreshment vehicles, industrial vehicles, and/or trail utility vehicles. These small utility vehicles can include a variety of components made of a variety of materials that are assembled together with fasteners. Some components can experience creep within the range of clamping loads typically used to fasten the components together. If creep occurs, the clamping load imparted on the components to secure the components can be diminished, and the assembly can become loose. Additionally, the fasteners may fall out. Shoulder bolts and non-creeping spacers have been used to secure components subject to creeping to components that are not subject to creeping to maintain a clamping load between the fastener and the non-creeping component. Shoulder bolts, however, are expensive and are only used in limited applications. The use of spacers adds another component to the fastening assembly thereby increasing the complexity and time required to fasten the components together. The spacer can also make assembly more difficult, especially if the components are not completely aligned. Thus, it would be advantageous to use a fastening assembly that is economical and easy to fasten. Additionally, it would be advantageous if the fastening assembly used readily available fasteners that can also be used in other applications on the small utility vehicle.

### SUMMARY

The present disclosure provides a fastening assembly. The fastening assembly can include a first component of a first material having a first material characteristic. The first component can have a first surface and a projection extending outwardly therefrom. The projection can define a through opening in the first component and can have a top surface. Additionally, the projection can have a height between the first surface and the top surface. The fastening assembly can further include a second component of a second material having a second material characteristic. The second material characteristic can be different than the first material characteristic. The second component can have a first aperture extending therethrough. The second component can have a first uncompressed thickness adjacent the first aperture. Furthermore, the second component can be positioned adjacent the first surface of the first component with the projection extending into the first aperture. The fastening assembly can also include a fastener. The fastener can extend into and engage with the projection. The fastener can impart a compressive force on the second component thereby securing the second component to the first component. The top surface of the projection can limit the force imparted by the fastener on the second component.

The present disclosure further provides a golf car. The golf car can include the fastening assembly provided herein.

The present disclosure further provides a method of securing two or more components together. The method can include positioning a first component having a first aperture extending therethrough on a second component having a projection extending outwardly therefrom. The projection can have an opening extending therethrough and can extend into the first aperture. The method can further include engaging a first portion of a fastener with the opening of the projection, thereby fastening the first and second components together with the fastener. Additionally, the method can include limiting a compressive force imparted on the first component by the fastener with a top surface of the projection.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a small utility vehicle, in this case in the form of a golf car, according to the present disclosure;

FIG. 2 is a fragmented perspective view of a portion of an instrument panel structure support of the small utility vehicle of FIG. 1 having extrusions thereon according to the present disclosure;

FIG. 3 is a fragmented cross sectional view through an extrusion on a cross member of the instrument panel structure support along line 3-3 of FIG. 2;

FIG. 4 is a fragmented perspective view of a portion of the instrument panel structure support of FIG. 2 with a floorboard component disposed thereon;

FIG. 5 is a fragmented perspective view of an instrument panel disposed on the floorboard component and the instrument panel structure support of FIG. 4;

FIG. 6 is a fragmented perspective view of a fastening assembly according to the present disclosure securing the instrument panel, floorboard component, and instrument panel structure support of FIG. 5;

FIG. 7 is a fragmented, exploded cross sectional view of the fastening assembly along line 8-8 of FIG. 6 prior to the securing of the components together;

FIG. 8 is a fragmented cross sectional view of the fastening assembly along line 8-8 of FIG. 6;

FIG. 9 is a perspective view of the backside of the fastening assembly of FIG. 6; and

FIG. 10 is a fragmented, exploded cross sectional view of another fastening assembly according to the present disclosure.

### DETAILED DESCRIPTION

The following description is merely exemplary in nature and is in no way intended to limit the present disclosure, application, or uses. Throughout this specification, like reference numerals will be used to refer to like elements. For example, like elements may be referred to by the reference numerals 15 and 15′.

According to the various embodiments, a raised projection or extrusion on a component of a small utility vehicle can be used to secure other components of the vehicle together. The extrusion can receive a fastener therein to hold the components together. The extrusion can be relatively rigid and engage directly with the fastener or indirectly with the fastener through other relatively rigid members, such as a washer. The extrusion can limit the compressive load imparted by the fastener on the other components. The engagement between the fastener and the extrusion can maintain the clamping load imparted between the fastener and the extrusion regardless of creeping of one or more components being secured by the fastener and extrusion.

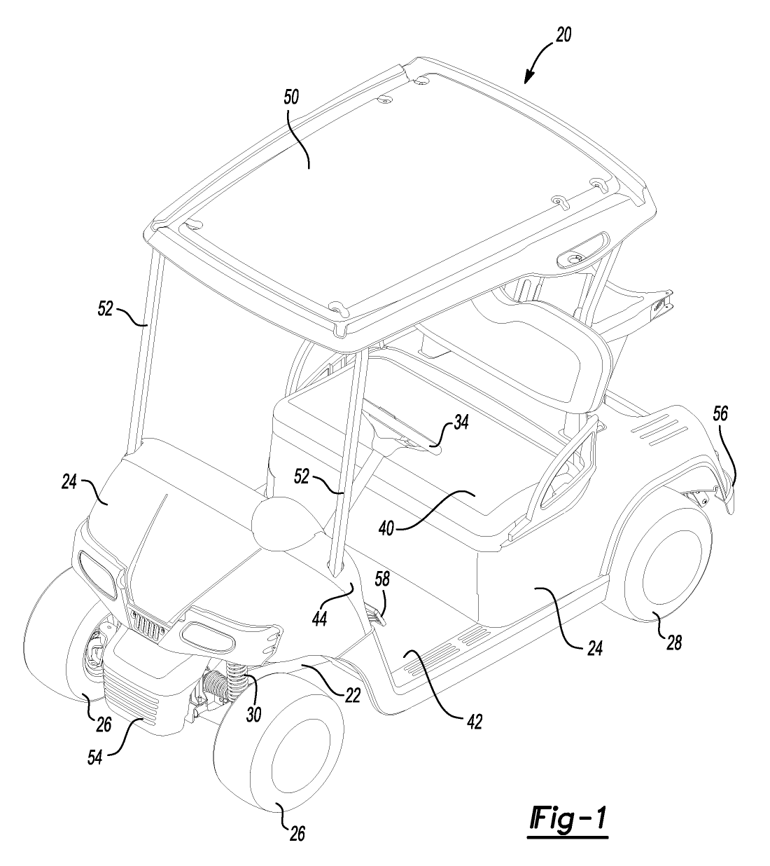

Referring to FIG. 1, an exemplary small utility vehicle 20, in this case in the form of a golf car, according to the present disclosure is shown. As used herein the term “small utility vehicle” includes, but is not limited to, shuttle personnel carriers, refreshment vehicles, industrial utility vehicles, golf cars, and/or trail utility vehicles. Vehicle 20 includes various components that are mounted to a frame 22. The components can vary based upon the configuration or type of small utility vehicle to be formed. Vehicle 20 can include various body panels 24. It should be appreciated that the body panels shown are merely exemplary in nature. Body panels 24 can be directly or partially attached to frame 22 and/or supported by other brackets or structural members that are coupled to frame 22. Frame 22 can also support a plurality of wheels including steerable wheels 26 in addition to powered or driven wheels 28. A front suspension system 30 can be used to support steerable wheels 26. Driven wheels 28 are commonly connected to a rear structural portion of frame 22 with a rear suspension system (not shown). A steering mechanism 34 can also be included to provide the steering input to steerable wheels 26.

Vehicle 20 may also include a seating area 40. A floorboard 42 can be included on a bottom portion of vehicle 20 in front of seating area 40. Furthermore, an instrument panel 44 can be included in a front portion of vehicle 20 and may house various components, such as instruments controlling the operation of vehicle 20 and/or indicating operational status of vehicle 20 along with storage compartments and the like by way of non-limiting examples.

A cover or roof 50 can be provided which can be supported from either frame 22 or a plurality of structural members 52 coupled thereto. Front and rear bumpers 54, 56 can be attached to frame 22. Other items that can be provided when vehicle 20 is in the form of a golf car include golf bag support equipment, accessory racks or bins, headlights, side rails, fenders or the like. Moreover, when vehicle 20 is configured as other types of vehicles, a rear-facing seat or multiple rows of seats may be included, a storage bed (tiltable or fixed) may be attached to the rear portion of vehicle 20, beverage compartments may be attached to the rear portion of vehicle 20 and the like, by way of non-limiting examples.

Vehicle 20 is commonly propelled by a power unit (not shown), which is commonly disposed behind or below seating area 40. The power unit can include an internal combustion engine assembly or a battery and electric motor assembly. The power unit drives driven wheels 28 and is typically coupled to a drive axle interconnecting driven wheels 28. The power unit enables driven wheels 28 to propel vehicle 20 in both a forward and rearward direction with steering input provided by steerable wheels 26 via input from steering mechanism 34. Vehicle 20 can also include a pedal assembly 58 that controls the output level of the power unit and the braking function of vehicle 20. Pedal assembly 58 can be attached to frame 22 and can extend through floorboard 42.

These various components of vehicle 20 can have differing material properties or characteristics. The differing material characteristics can affect the ability of a fastening assembly to maintain a secure attachment. The differing material characteristics may be related to a propensity of the material to compress under a given loading. For example, the structural and fastening members of vehicle 20 can be made of relatively rigid materials with relatively high yield strengths, such as metals including steel and aluminum, which may not compress under the clamping load of the fastening assembly. Other components, such as body panels 24, floorboard 42, and instrument panel 44, can be made of relatively less rigid materials with relatively low yield strengths, such as polymeric materials including glass-filled and talc-filled polypropylene, which may compress under the clamping load. Moreover, the differing material characteristics may be related to a propensity of the material to creep under a given loading. For example, one or more of the relatively less rigid components may creep over time under the clamping load and other nominal conditions, while the relative rigid components may not creep under the clamping load and other nominal conditions. Thus, the clamping load imparted on one or more of the relatively less rigid components may be diminished, and the assembly may become loose. According to the present disclosure, as described in further detail below, a fastening assembly can maintain a secure attachment between relative rigid components irrespective of whether relatively less rigid components creep and the clamping load imparted thereon is diminished.

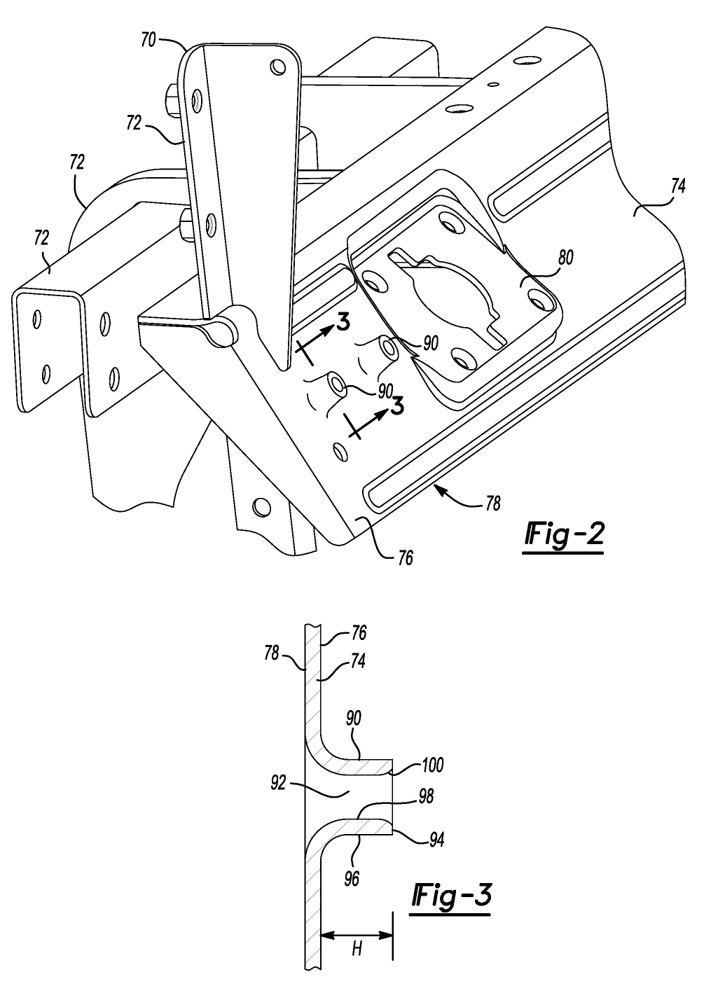

Referring to FIG. 2, a portion of a relatively rigid instrument panel structure support 70 of vehicle 20 is shown. Instrument panel structure support 70 can support various components of vehicle 20. Instrument panel structure support 70 can include a plurality of structural members 72 which can be fixedly coupled together. Instrument panel structure support 70 can be rigid and can be steel. A cross member 74 of instrument panel structure support 70 can provide a foundation for the coupling of various components of vehicle 20 to instrument panel structure support 70. Cross member 74 can be attached to and supported by other structural members of instrument panel structure support 70. Cross member 74 can include a front surface 76, a back surface 78, a steering assembly mounting feature 80, and a plurality of raised projections or extrusions 90 extending outwardly from front surface 76. Extrusions 90 can be used to fasten components of vehicle 20 together according to the present disclosure.

Referring to FIG. 3, extrusion 90 can extend outwardly from front surface 76 of cross member 74 and include an aperture 92 which extends through cross member 74. Extrusion 90 can further include a top surface 94, an outer surface 96, and an inner surface 98. Extrusion 90 can have a height H between front surface 76 and top surface 94. Inner surface 98 can include a curved portion 100 as it approaches top surface 94.

Extrusions 90 can be integral with cross member 74 and be extruded therein. Extrusions 90 can be formed by a multi-step stamping process wherein extrusion 90 is progressively formed from a portion of cross member 74 by multiple stamping steps. Additionally, the process can include a final stamping to form top surface 94 such that height H is of a desired magnitude. The final stamping can also create curved portion 100 of inner surface 98.

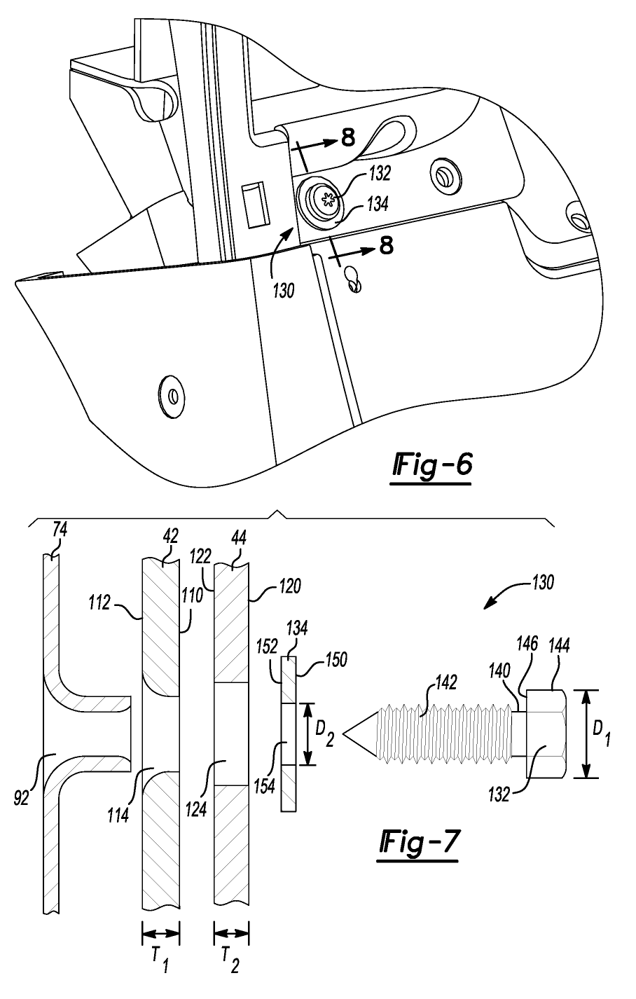

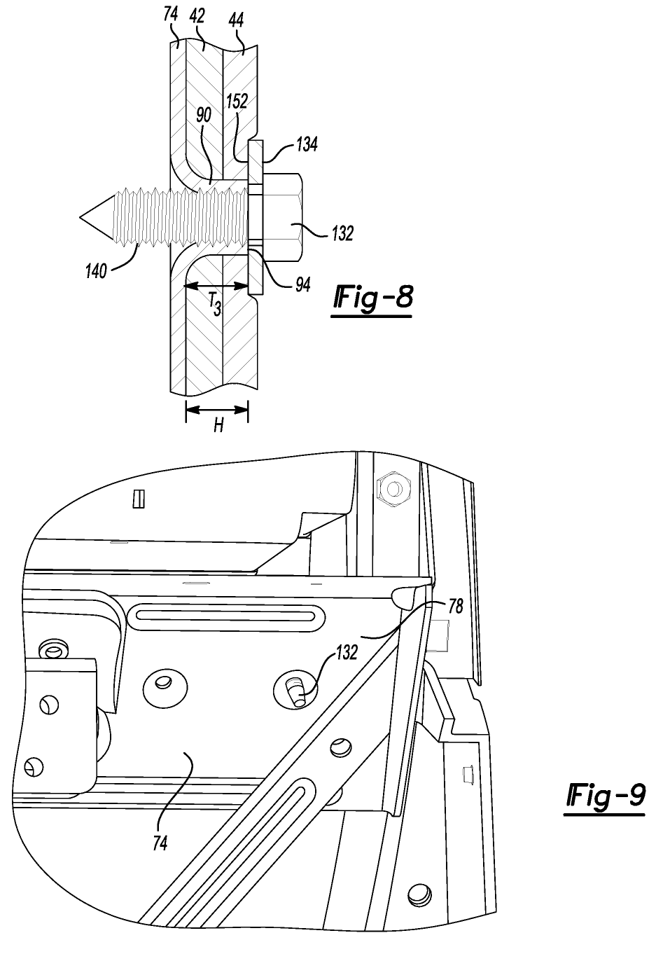

Referring to FIGS. 4 and 7, a portion of floorboard 42 of vehicle 20 can be disposed on cross member 74 around extrusions 90 and secured thereto. Floorboard 42 can include a front surface 110, a back surface 112, and apertures 114 extending therebetween. Floorboard 42 can also include a recess 116 to accommodate steering assembly mounting feature 80. Floorboard 42 can have an uncompressed thickness T₁ between front and back surfaces 110 and 112 proximate apertures 114. Floorboard 42 can be made of glass-filled polypropylene.

According to the present disclosure, extrusions 90 can align floorboard 42. Floorboard 42 can be disposed proximate cross member 74 with extrusions 90 extending into apertures 114. When floorboard 42 is so disposed, floorboard 42 can have a predetermined alignment with respect to cross member 24 and other components of vehicle 20. For example, recess 116 can be complementarily positioned with respect to steering assembly mounting feature 80. Additionally, floorboard 42 can also be aligned so as to have a complementary position with respect to pedal assembly 58 (shown in FIG. 1).

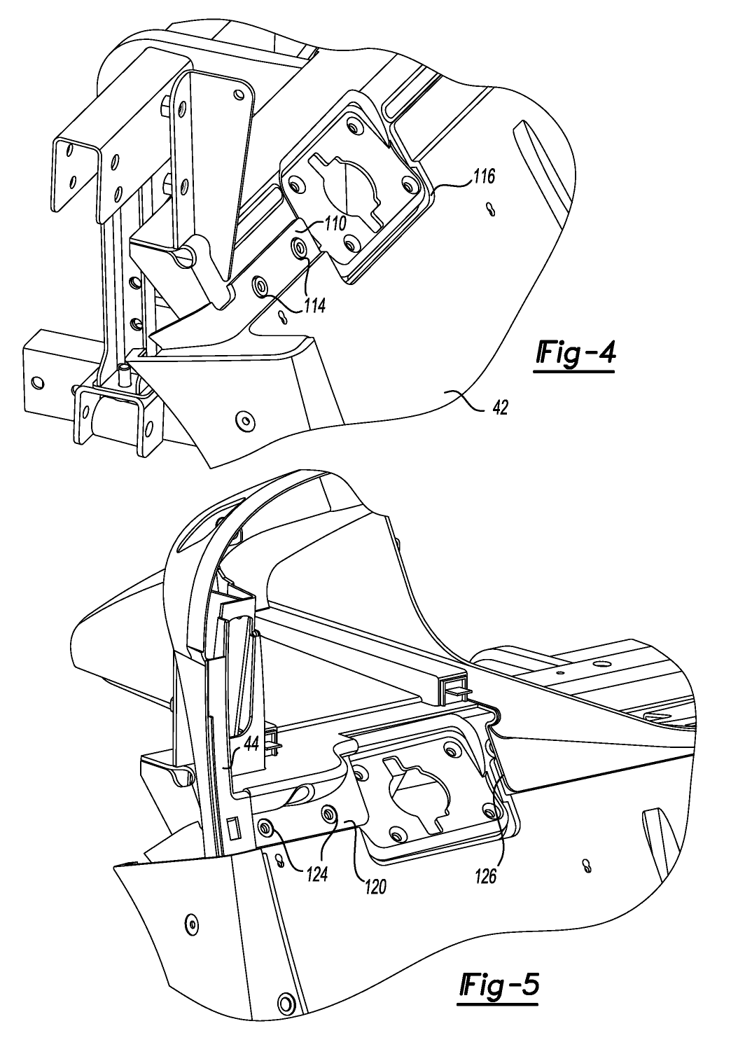

Referring to FIGS. 5 and 7, instrument panel 44 can be positioned on vehicle 20 with portions of instrument panel 44 overlapping portions of instrument panel structure support 70, cross member 74, and floorboard 42. Instrument panel 44 can include a front surface 120, a back surface 122, and apertures 124 extending therebetween. Instrument panel 44 can also include a recess 126 to accommodate steering assembly mounting feature 80. Instrument panel 44 can have an uncompressed thickness T₂ between front and back surfaces 120 and 122 proximate apertures 124. Instrument panel 44 can be made of talc-filled polypropylene.

According to the present disclosure, extrusions 90 can also align instrument panel 44. Instrument panel 44 can be disposed proximate cross member 74 with extrusions 90 extending into apertures 124. When instrument panel 44 is so disposed, instrument panel 44 can have a predetermined alignment with respect to cross member 74, floorboard 42 and other components of vehicle 20. For example, recess 126 can be complementarily positioned with respect to steering assembly mounting feature 80 and recess 116.

Referring to FIGS. 6-9, a fastening assembly 130 can include extrusion 90, a fastener 132, and a washer 134. According to the present disclosure, fastening assembly 130 can secure two or more components of vehicle 20 together. For example, fastening assembly 130 can secure floorboard 42 and instrument panel 44 to cross member 74, as is described in further detail below.

Fastener 132 can secure one or more components of vehicle 20 to cross member 74. Fastener 132 can include an elongated stem 140 having threads 142 thereon. Fastener 132 can further include a head 144 having a shoulder 146 and a diameter D₁. Fastener 132 can be a self-tapping fastener and threads 142 can be self-tapping threads. Suitable fasteners 132 can include TAPTITE® fasteners available from Textron Fastening Systems, Inc. of Troy, Mich. Fastener 132 can be steel.

A washer 134 can be included in fastening assembly 130. Washer 134 can have a top surface 150, a bottom surface 152, and an aperture 154 extending therethrough. Aperture 154 can be larger than stem 140 of fastener 132 and can have a diameter D₂ less than diameter D₁. Thus, washer 134 can be disposed on fastener 132 with top surface 150 contacting shoulder 146 of head 144. Washer 134 can be steel.

In operation, fastening assembly 130 can secure floorboard 42 and instrument panel 44 to cross member 74. To secure floorboard 42 and instrument panel 44 together with cross member 74, the components can be positioned as shown in FIG. 5. Furthermore, fastener 132 can be aligned relative to extrusion 90, floorboard 42, and instrument panel 44 as shown in FIG. 7. Stem 140 can be inserted into aperture 92 of extrusion 90 through aperture 114 of floorboard 42 and aperture 124 of instrument panel 44. Curved portion 100 of inner surface 98 of extrusion 90 can define a funnel-shaped portion of aperture 92 proximate top surface 94 and can help extrusion 90 receive fastener 132. When stem 140 extends into aperture 92, threads 142 can engage inner surface 98. Threads 142 can be self tapping and thus can deform inner surface 98 during engagement. With threads 142 engaging inner surface 98, fastener 132 can be rotated to drive stem 140 longitudinally into extrusion 90.

Head 144 and washer 134 can engage floorboard 42 and instrument panel 44 and can impart a load thereon depending upon a combination of the thicknesses of floorboard 42 and instrument panel 44 (T₁, T₂) relative to height H of extrusion 90. When the combined thickness (T₁, T₂) is greater than the height H of extrusion 90, fastener 132 can compress one or both of floorboard 42 and instrument panel 44 to a combined thickness equal to height H depending upon the clamping load being imparted by fastener 132 and the relative material properties. For example, compression of one or more of floorboard 42 and instrument panel 44 can be possible as a result of the differing material properties of the components, such as cross member 74 and fastener 132 being relatively rigid and having relatively higher yield strengths and one or more of floorboard 42 and instrument panel 44 being relatively less rigid and having relatively lower yield strengths.

The compression of one or more of floorboard 42 and instrument panel 44 and the load imparted thereon by fastener 132 can be limited. Fastener 132 and washer 134, along with cross member 74, can be made of relatively rigid materials which do not compress under the clamping load imparted by fastener 132. As shown in FIG. 8, stem 140 of fastener 132 can be driven longitudinally into extrusion 90 until bottom surface 152 of washer 134 engages top surface 94 of extrusion 90. This engagement limits the compression of one or more of floorboard 42 and instrument panel 44 to a combined thickness T₃ proximate extrusion 90 equal to height H. Height H of extrusion 90 can be set to result in a predetermined total amount of compression of one or more of floorboard 42 and instrument panel 44. For example, the amount of compression can be set to be one millimeter. Additionally, with washer 134 in contact with extrusion 90, a predetermined clamping load can be applied between cross member 74 and fastener 132. The predetermined clamping load can be within a range of magnitudes so as to both secure the components during use of vehicle 20 and avoid undesirable deformation of the components, such as cracking. Additionally, fastener 132 can extend through cross member 74, as shown in FIG. 9.

According to the present disclosure, one or more of floorboard 42 and instrument panel 44 can creep under the clamping load imparted by fastener 132. Thus, over time, one or more of floorboard 42 and instrument panel 44 can deform and lose contact with cross member 74 or washer 134, and as a result, the clamping load imparted on floorboard 42 and instrument panel 44 can be lost. As extrusion 90 and washer 134 can directly engage, the clamping load between cross member 74 and fastener 132 can be maintained irrespective of whether the clamping load on floorboard 42 and instrument panel 44 is maintained. Thus, over time, fastening assembly 130 can remain secure.

According to the present disclosure, a fastening assembly using a raised projection or extrusion on a component of a small utility vehicle can secure other components of the vehicle together. It is to be understood that fastening assembly 130 is described herein as a non-limiting example. An extrusion can be formed on a variety of vehicle components and the fastening assembly employed. Additionally, a fastening assembly can combine a varying number of components and a variety of components together.

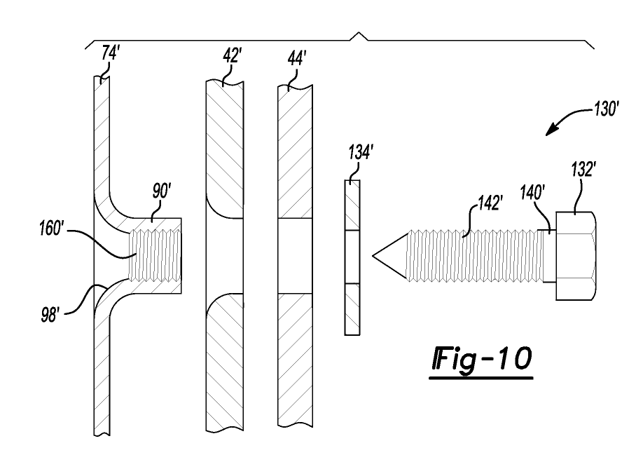

Referring to FIG. 10, an alternative fastening assembly 130′ can include threads 160′ on inner surface 98′ of extrusion 90′. Additionally, threads 142′ of fastener 132′ can be complementary to threads 160′. Thus, when stem 140′ extends into aperture 92′, threads 160′ and threads 142′ can engage and pull fastener 132′ into aperture 92′ due to relative rotation.

It is to be understood that the present disclosure can vary from the examples shown. The present disclosure can apply to a variety of small utility vehicles and a variety of vehicle components. Additionally, the golf car described herein can have a variety of configurations and include a variety of components. The components can be made of a variety of materials. Additionally, fasteners with a variety of configurations can be employed in the fastening assembly of the present disclosure. For example, fasteners can have a large integral shoulder and be used without corresponding washers. Other fasteners can also be used, including but not limited to bolts with corresponding nuts, rivets, and weld nuts, although all of the benefits of the present disclosure may not be realized. Furthermore, in various embodiments, the thread on the fastener or the protrusion can be but is not limited to cut thread or rolled thread. Thus, description herein is merely exemplary in nature and variations that do not depart from the gist of that which is described are intended to be within the scope of the disclosure. Such variations are not to be regarded as a departure from the spirit and scope of the disclosure.

What is claimed is:

1. A fastening assembly comprising:
a first component of a first material having a first material characteristic, the first component having a first surface and a projection extending outwardly therefrom, the projection defining a through opening in the first component and having a top surface, the projection having a height between the first surface and the top surface;
a second component of a second material having a second material characteristic, the second material characteristic being different than the first material characteristic, the second component having a first aperture extending therethrough, the second component having a first uncompressed thickness adjacent the first aperture, the second component being positioned adjacent the first surface of the first component with the projection extending into the first aperture; and
a fastener extending into and engaging with the projection and imparting a compressive force on the second component thereby securing the second component to the first component, the top surface of the projection limiting the force imparted by the fastener on the second component.

2. The fastening assembly of claim 1, wherein the fastener includes a first portion for engaging with the through opening of the projection and a second portion for engaging with the top surface of the projection.

3. The fastening assembly of claim 2, wherein the first portion of the fastener is threaded.

4. The fastening assembly of claim 3, wherein the through opening has threads complementary to the threaded portion of the fastener.

5. The fastening assembly of claim 2, further comprising a washer disposed on the fastener between the second portion and the top surface of the projection, the washer directly engaging with the top surface and the second portion.

6. The fastening assembly of claim 1, wherein a portion of the second component adjacent the first aperture is compressed a predetermined distance by the fastener.

7. The fastening assembly of claim 6, wherein the height of the projection is less than the first uncompressed thickness of the second component.

8. The fastening assembly of claim 6, wherein the predetermined distance equals a difference between the first uncompressed thickness of the second component and the height of the projection.

9. The fastening assembly of claim 1, further comprising a third component having a second aperture extending therethrough, the third component having a second uncompressed thickness adjacent the second aperture, the third component disposed on the second component with the projection extending into the second aperture, and wherein the fastener imparts a compressive force on both the second and third components thereby securing the second and third components to the first component.

10. The fastening assembly of claim 9, wherein the third component is of a third material having a third material characteristic, the third material characteristic being different than the first material characteristic, and the fastener compresses a portion of the second and third components adjacent the projection a predetermined distance.

11. The fastening assembly of claim 9, wherein the third component is of a third material having a third material characteristic, the third material characteristic being different than the first material characteristic, and the fastener compresses a portion of only one of the second and third components adjacent the projection.

12. The fastening assembly of claim 1, wherein the first material is a metal and the second material is a polymer.

13. The fastening assembly of claim 1, wherein the first and second material characteristics are indicative of the propensities of the associated materials to compress under a given loading and the second material characteristic indicates a relatively greater propensity to compress than the first material characteristic.

14. The fastening assembly of claim 1, wherein the first and second material characteristics are indicative of the propensities of the associated materials to creep under a given loading and the second material characteristic indicates a relatively greater propensity to creep than the first material characteristic.

15. A golf car including the fastening assembly of claim 1.

16. A golf car comprising:
a first component of a first material having a first material characteristic, the first component having a first surface and a projection extending outwardly therefrom, the projection defining a through opening in the first component and having a top surface, the projection having a height between the first surface and the top surface;
a second component of a second material having a second material characteristic, the second material characteristic being different than the first material characteristic, the second component having a first aperture extending therethrough, the second component having a first uncompressed thickness adjacent the first aperture, the second component being positioned adjacent the first surface of the first component with the projection extending into the first aperture; and
a fastener extending into and engaging with the projection and imparting a compressive force on the second component thereby securing the second component to the first component, the top surface of the projection limiting the force imparted by the fastener on the second component.

17. The golf car of claim 16, wherein a portion of the second component adjacent the first aperture is compressed a predetermined distance by the fastener.

18. The golf car of claim 17, wherein the height of the projection is less than the first uncompressed thickness of the second component.

19. The golf car of claim 17, wherein the predetermined distance equals a difference between the first uncompressed thickness of the second component and the height of the projection.

20. The golf car of claim 16, further comprising a third component having a second aperture extending therethrough, the third component having a second uncompressed thickness adjacent the second aperture, the third component disposed on the second component with the projection extending into the second aperture, and wherein the fastener imparts a compressive force on both the second and third components thereby securing the second and third components to the first component.

21. The golf car of claim 20, wherein the second component is a floorboard of a golf car and the third component is an instrument panel of a golf car.

22. The golf car of claim 21, wherein the first component is a bracket connected to a frame of a golf car.

23. The golf car of claim 16, wherein the fastener is a self-tapping fastener.

24. A method of securing two or more components together, the method comprising:
(a) positioning a first component having a first aperture extending therethrough on a second component having a projection extending outwardly therefrom, the projection having an opening extending therethrough, the projection extending into the first aperture;
(b) engaging a first portion of a fastener with the opening of the projection, thereby fastening the first and second components together with the fastener; and
(c) limiting a compressive force imparted on the first component by the fastener with a top surface of the projection.

25. The method of claim 24, wherein the first component has a first material characteristic and the second component has a second material characteristic different than the first material characteristic, and further comprising deforming the first component with the fastener.

26. The method of claim 25, wherein deforming the first component includes plastically deforming a portion of the first component adjacent the aperture with the fastener.

27. The method of claim 25, further comprising compressing a portion of the first component adjacent the first aperture a predetermined distance by the force imparted by the fastener.

28. The method of claim 24, wherein (a) includes positioning a third component having a second aperture extending therethrough adjacent the first and second components, the projection extending into the second aperture.

29. The method of claim 28, wherein the first component has a first material characteristic, the second component has a second material characteristic, and the third component has a third material characteristic, the second material characteristic being different than the first and third material characteristics, and further comprising deforming the first and third components with the fastener.

30. The method of claim 24, wherein (a) further includes aligning the first component relative to the second component.

31. The method of claim 24, wherein (b) includes engaging a threaded portion of the fastener with a complementarily threaded surface of the opening.

32. The method of claim 24, wherein (b) includes engaging a self-tapping threaded portion of the fastener with the opening.

33. The method of claim 24, wherein (c) includes directly engaging a second portion of the fastener with the top surface of the projection.

34. The method of claim 24, wherein (c) includes engaging a second portion of the fastener with the top surface of the projection through a washer disposed around the fastener.
